(19) United States
(12) Patent Application Publication
(10) Pub. No.: US 2005/0204894 A1
(43) Pub. Date: Sep. 22, 2005

(54) Support strap for a musical instrument or a musical instrument case

(76) Inventor: Wolfgang Dimbath, Erlangen (DE)

Correspondence Address: HENRY M FEIEREISEN, LLC, 350 FIFTH AVENUE, SUITE 4714, NEW YORK, NY, 10118, US

(21) Appl. No.: 11/081,245

(22) Filed: Mar. 16, 2005

(30) Foreign Application Priority Data
Mar. 20, 2004 (DE) 20 2004 004 369.6

(51) Int. Cl. G10D 3/00; G10G 5/00

(52) U.S. Cl. 84/327

(57) ABSTRACT

A strap construction for carrying a musical instrument, in particular for attachment to the musical instrument or case for the musical instrument, includes a strap, and an attachment member, which is connected to the strap. In order for the bearer to carry the musical instrument or musical instrument case more comfortably, the strap in its entirety, or part of the strap, or the attachment member, is made of a highly elastic material comprised of chloroprene rubber so as to be responsive to tensile stress.

### CROSS-REFERENCES TO RELATED APPLICATIONS

This application claims the priority of German Patent Application, Serial No. 20 2004 004 369.6, filed Mar. 20, 2004, pursuant to 35 U.S.C. 119(a)-(d).

### BACKGROUND OF THE INVENTION

The present invention relates, in general, to a strap construction, and more particularly to a support strap for carrying a musical instrument or a musical instrument case.

Nothing in the following discussion of the state of the art is to be construed as an admission of prior art.

Support straps of a type involved here can be secured permanently or detachably to the musical instrument or musical instrument case. The strap may be constructed as a neck strap or a shoulder strap in the form of a band or belt, or may be a shoulder strap or garniture strap for a musical instrument knapsack. Thus, the term “case” as referred to in the following description is used in a generic sense and includes knapsack as well as any carrying bag, stable housing, or suitcase, appropriately constructed for carrying and protecting a musical instrument from damaging impacts. The term “musical instrument” is also used in a generic sense in the following description and may include, for example, tube, woodwind instrument such as saxophone, but also guitar, accordion, etc.

Typically, a conventional strap construction for such a case is made of a web construction material of low elasticity, such as plastic, in particular polypropylene. To prevent pressure points on the shoulder or back of a bearer, the strap may be padded, in particular using plastic pads made, e.g., of foam material.

When relatively heavy musical instruments are involved, e.g. an accordion, having a weight of 18 to 20 kg, with or without case, the bearer has difficulties to support this type of heavy instrument because of the movements the instrument undergoes. In particular, when the bearer walks a longer distance, the support of this instrument becomes very laborious, adversely affecting the bearer's mood.

It would therefore be desirable and advantageous to provide an improved strap construction to obviate prior art shortcomings and to enhance the support and feel for carrying a musical instrument or musical instrument case.

### SUMMARY OF THE INVENTION

According to one aspect of the present invention, a strap construction for attachment to a musical instrument or a musical instrument case includes a strap, and an attachment member connected to the strap, wherein the strap in its entirety, or part of the strap, or the attachment member, is made of a highly elastic material comprised of chloroprene rubber so as to be responsive to tensile stress.

Chloroprene rubber is known commercially under the name “neoprene”, and is used to date, for example, as material for diving suits, or as insulation of beverage containers.

The present invention resolves prior art problems by using neoprene as highly elastic material for a strap construction because the musical instrument or the case is cushioned during carrying and because neoprene can be subjected to tensile stress. As a consequence, the bearer perceives a lighter feel when the instrument or the case is carried. In particular, when the carried instrument or case, which accommodates the instrument, is heavy, e.g. 10 to 12 kg, a strap construction according to the present invention exhibits its positive effect. When the bearer or musician steps on the ground or floor, as he walks or runs or moves in rhythm, the cushioning effect of the strap construction intensifies as the weight increases. A strap construction according to the present invention has shown especially comfortable and pleasant for instruments, such as an accordion, which can weigh between 17 and 20 kg, or for carrying a large keyboard in a case, which can weigh up to 35 kg.

According to another feature of the present invention, the strap may be made in its entirety of the highly elastic material and has opposite ends, with at least one of the ends being constructed for permanent or detachable securement.

According to another feature of the present invention, the strap construction may have a first strap portion made of the highly elastic material, and a second strap portion made of typical web construction material, e.g. propylene. Suitably, at least one of the first and second strap portions may be padded.

According to another feature of the present invention, a connection piece may be provided for interconnecting the first and second strap portions. Hereby, either the connection piece or the first and second strap portions may be made of chloroprene rubber. Suitably, the connection piece may be secured to the first and second strap portions by sewing, riveting, and gluing.

According to another feature of the present invention, the strap has opposite ends, with at least one of the ends being constructed for application of a seam. The strap can then be secured to the musical instrument case or the attachment member by this seam. The attachment member may hereby be made of typical web construction material.

According to another feature of the present invention, the strap may be secured on one end to an attachment member of highly elastic material or of less elasticity. The securement of the strap to the attachment member and the securement of the attachment member to the case may be realized by sewing, riveting, eyelets etc.

According to another feature of the present invention, the elastic material may be lined with a layer of nylon-jersey. In this way, a substantial tear-resistance can be accomplished. As an alternative, it is also possible to incorporate an intermediate layer, e.g. a ductile band, such as, e.g. polypropylene band, to increase tear resistance.

A strap construction according to the present invention may be used as a single strap for direct securement or for holding a musical instrument or to support a musical instrument case, or may be used as a strap of a strap garniture.

According to another aspect of the present invention, a musical instrument case includes a shell having an interior for housing a musical instrument, and a strap construction for attachment to the shell, wherein the strap construction includes a strap; and an attachment member connected to the strap, wherein the strap in its entirety, or part of the strap, or the attachment member, is made of a highly elastic material comprised of chloroprene rubber.

According to another aspect of the present invention, a musical instrument includes a strap construction for attachment to the musical instrument, with the strap construction including a strap; and an attachment member connected to the strap, wherein the strap in its entirety, or part of the strap, or the attachment member, is made of a highly elastic material comprised of chloroprene rubber.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a plan view of one embodiment of a strap construction according to the present invention;

FIG. 2 is a plan view of the strap construction of FIG. 1 with different type of securement;

FIG. 3 is a plan view of another embodiment of a strap construction according to the present invention;

FIG. 4 is a plan view of another embodiment of a strap construction according to the present invention;

FIG. 5 is a plan view of another embodiment of a strap construction according to the present invention;

FIG. 6 is a plan view of a variation of the strap construction of FIG. 5;

FIG. 7 is a plan view of another embodiment of a strap construction according to the present invention;

FIG. 8 is a plan view of a strap garniture with two straps, embodying the subject matter of the present invention;

FIG. 9 is a perspective illustration of a musical instrument case accommodating a metallic wind instrument and provided with a strap construction in knapsack configuration;

FIG. 10 is a plan view of an exemplary guitar provided with a strap construction according to the present invention;

FIG. 11 is a perspective view of an exemplary saxophone provided with a strap construction according to the present invention;

FIG. 12 is a side view of an arcuate strap of a strap construction according to the present invention;

FIGS. 13-18 are plan views of variants of an arcuate configuration of a strap of a strap construction according to the present invention;

FIGS. 19-22 are plan views of still further variants of an arcuate configuration of a strap of a strap construction according to the present invention; and

FIG. 23 is a fragmentary side view of another embodiment of a strap construction according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

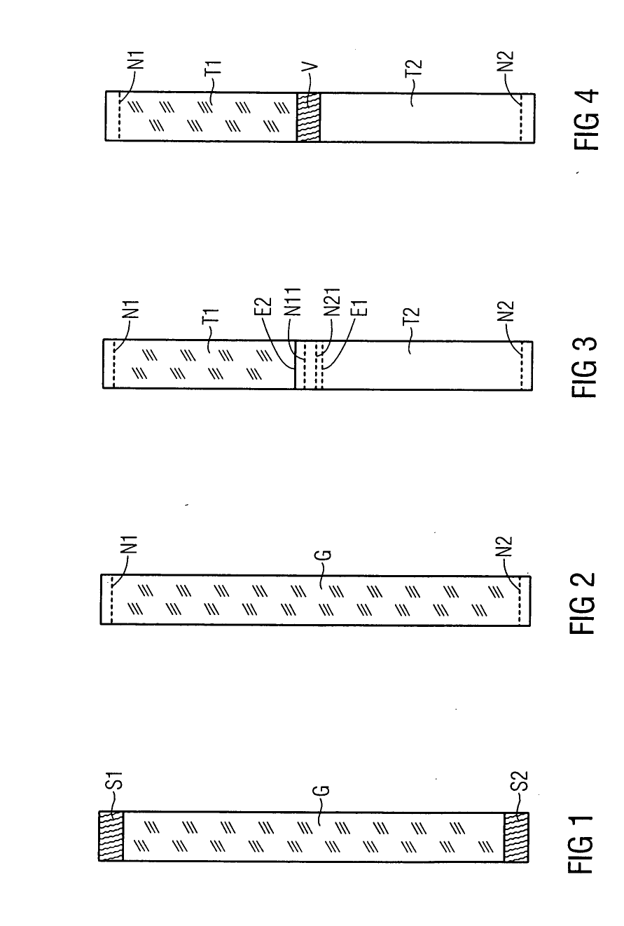

Turning now to the drawing, and in particular to FIG. 1, there is shown a plan view of one embodiment of a strap construction according to the present invention, including a strap G made in its entirety of a highly elastic, springy material (indicated by dashed lines), namely chloroprene rubber, which is available in the trade under the name neoprene. In order to enhance a resistance against tearing, the highly elastic strap material can be coated or laminated with nylon jersey. The strap G is constructed for attachment to an unillustrated musical instrument case, e.g. knapsack or carrying suitcase constructed to suit an outer contour of the musical instrument and provided optionally with a handle, for accommodating a musical instrument, in particular heavy musical instrument such as an accordion. As shown in FIG. 1, the strap G has opposite end members S1, S2 for detachable or permanent connection or attachment to the musical instrument case. Permanent securement of the end members S1, S2 may be realized by sewing, riveting, gluing, etc, whereas a detachable securement may be implemented by snap hooks, eyelets, quick-action closure, velcro, pressure knobs, etc.

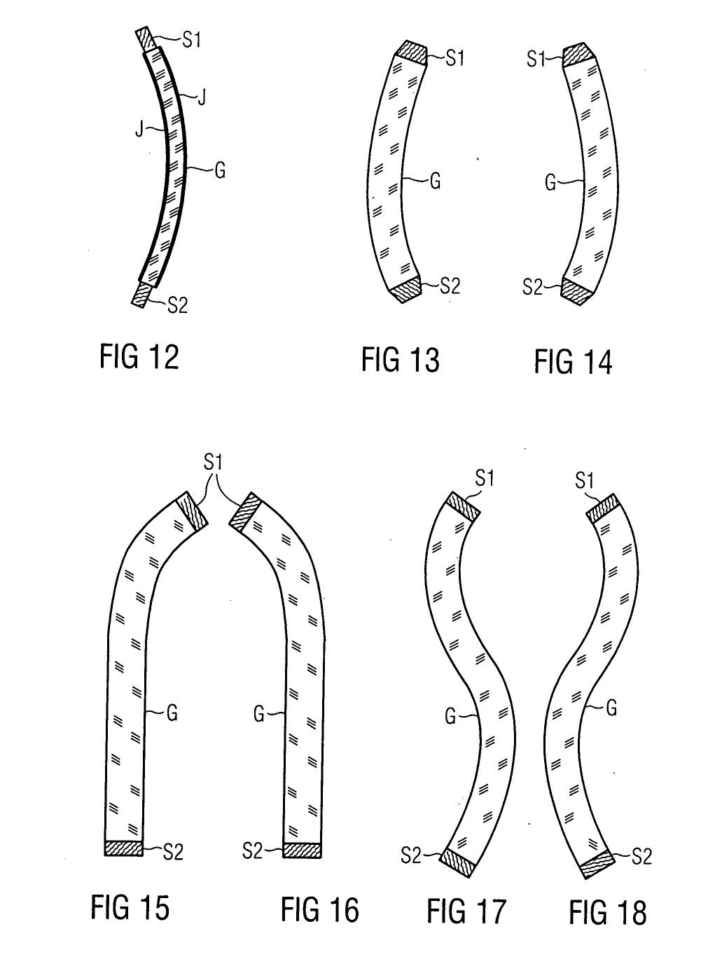

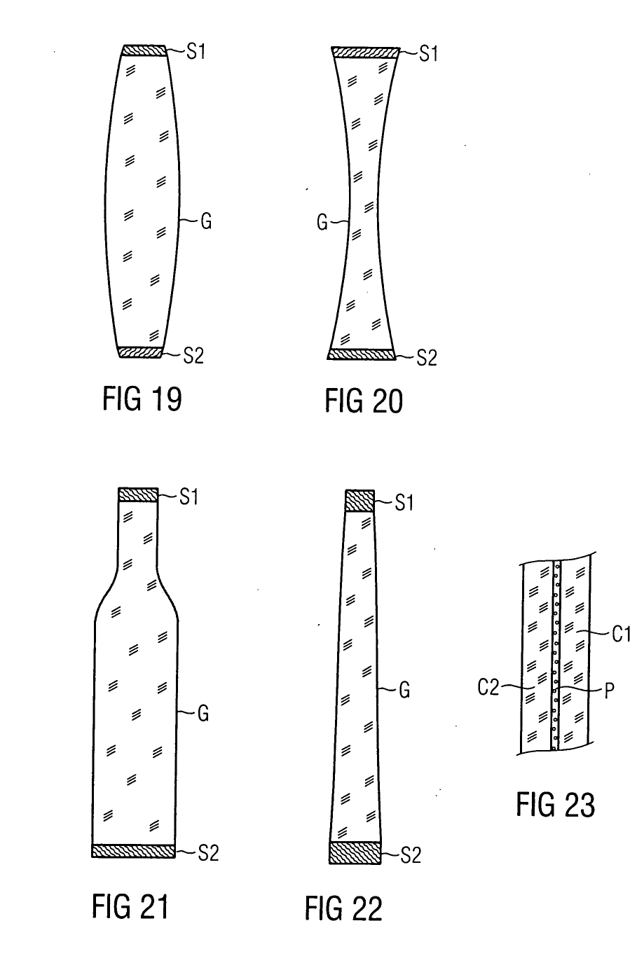

As shown in FIG. 12, the strap G may have a curved or arcuate configuration, and thus need not be planar and disposed in the drawing plane or parallel thereto. To better conform to the bearer's body, the strap G is bent out of the drawing plane. In other words, the bearer-proximal surface may extend non-planar. FIG. 12 also shows the coating of the strap G of chloroprene rubber with thin layers J of nylon jersey. As an alternative, the strap G may also be curved to the right, viewed from the bearer, as shown in FIGS. 13 or 15, or to the left, as shown in FIGS. 14 and 16. FIGS. 17 and 18 illustrate examples of S-shaped configurations of the strap G, whereas FIGS. 19 to 22 show non-rectangular configurations of the strap G, such as convex (bulbous) configuration (FIG. 19), concave configuration (FIG. 20), bottle-shaped configuration (FIG. 21), or trapezoidal configuration (FIG. 22).

The strap G may also be composed of two or more layers of neoprene in order to suit the cushioning effect of the strap G to the weight of the instrument. In order to ensure a tear resistance, safety webs may be incorporated inwardly of the neoprene layers. FIG. 23 shows a particular example of such a strap construction, in which the strap G has two neoprene layers C1, C2 and an intermediate layer P between the neoprene layers C1, C2. The intermediate layer P may be a more or less elastic band or web, e.g. of polypropylene or textile material. Of course, an adhesive may also be used as intermediate layer P.

Referring now to FIG. 2, there is shown a modification of the strap G which is again made of chloroprene rubber (neoprene) in its entirety and has opposite ends which are permanently sewed to an unillustrated musical instrument case via seams N1, N2, respectively.

FIG. 3 shows another embodiment of a strap construction according to the present invention, whose strap has a first strap portion Ti of chloroprene rubber, and a second strap portion T2 made of typical web material, e.g. propylene fabric. The abutting strap portions T1, T2 are interconnected by seams N11, N21, whereby the opposing ends of the strap portions T1, T2 overlap one another. Of course, joining of the strap portions T1, T2 may also be realized by riveting or gluing. The strap portion T1 and/or the strap portion T2 may be lined on the inside in an area facing the bearer with a padding material to protect the bearer. This padding may be realized in any suitable manner, e.g. resembling a padded knapsack strap.

The strap construction in FIG. 4 corresponds substantially to the strap construction of FIG. 3, with the difference residing in the flush-mounted connection of the strap portions T1, T2 by a particular connection piece V. The connection piece V can be joined with the confronting ends of the strap portions T1, T2 by gluing or by sewing, and may be made of plastic or leather. The configuration of the connection piece V is suited to the configuration of the strap. In FIG. 4, the connection piece V has a rectangular configuration.

FIG. 5 shows another embodiment of a strap construction according to the present invention, whose strap includes two strap portions T11, T12 of highly elastic chloroprene rubber, and a further strap portion T21 which is longer in dimension than the strap portions T11, T12 and made of traditional rubber material, such as polypropylene. The strap portions T11, T21 are connected to the strap portion T21 by connection pieces V11, V12 which are again made of stable material, such as leather, plastic or other synthetic material. Optionally, the strap portion T21 may be bent out of the drawing plane in a manner shown in FIG. 12, or have an arcuate configuration as shown in FIGS. 13 to 18.

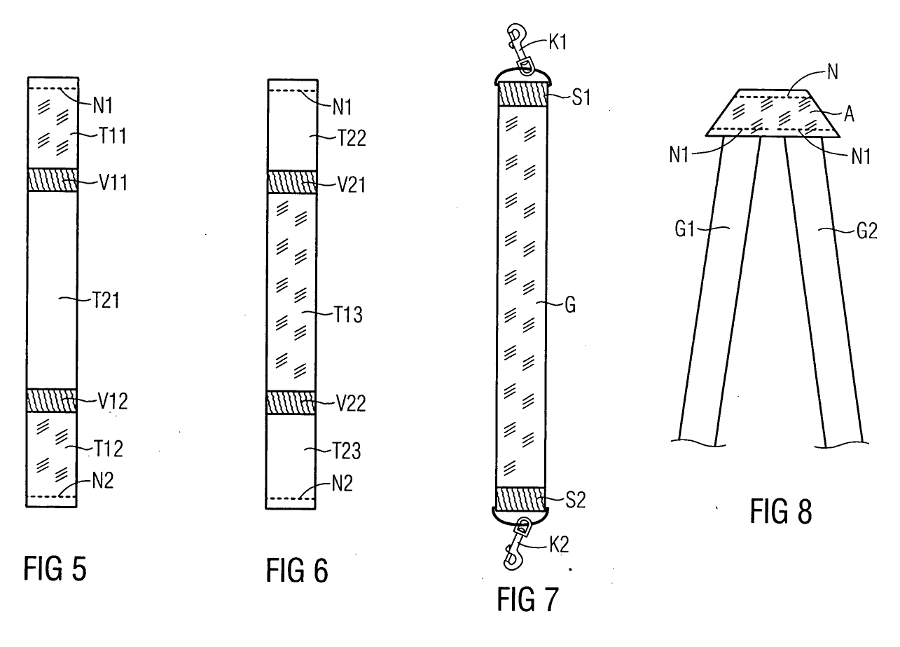

FIG. 6 shows a strap construction according to the present invention, which differs only in a reversal of the materials used. In other words, the longer strap portion T13 between the strap portions T22, T23 is now made of neoprene, while the strap portions T22, T23 are made of traditional rubber material and secured to the unillustrated musical instrument case via seams N1, N2, Connection pieces V21, V22 are again provided to join the strap portions T22, T23 to the strap portion T13. Padding material may, optionally, be provided for at least one of the strap portions T13, T22, T23, and the strap portion T13 may be bent out of the drawing plane in a manner shown in FIG. 12, or have an arcuate configuration as shown in FIGS. 13 to 18.

The strap G of the strap construction of FIG. 7 corresponds to the strap construction of FIG. 1 and thus is made in its entirety of neoprene. The end members S1, S2 are provided with clips or snap hooks K1, K2, respectively, to allow a detachable securement to an unillustrated musical instrument knapsack. Of course, the securement of the strap G may also be realized via seams N1, N2, as shown in FIGS. 2 to 6, or by a combination of snap hooks K1 and seam N2.

FIG. 8 shows a strap garniture according to the present invention, which includes two straps G1, G2 for use with a musical instrument knapsack. The straps G1, G2 are securely fixed to a substantially trapezoidal attachment member A via seams N1. The attachment member A is made of highly elastic material, i.e. neoprene, whereas the straps G1, G2 are made of conventional web material such as textile, nylon, polyester, polypropylene, etc. The straps G1, G2 may be padded. The elastic attachment member A is secured by a seam N to an unillustrated musical instrument case. Of course, the permanent securement of the attachment member A may also be realized by any other suitable joining method known to the artisan. Also a detachable securement of the attachment member A is conceivable and may be realized by any of the joining methods known to the artisan.

It will be understood by persons skilled in the art that the attachment member A may, of course, also be made of traditional material, whereas the straps G1, G2 may be made of neoprene, as described above in connection with FIGS. 1 to 7.

Viewing FIGS. 1 to 8 collectively, it can be seen that the seams N1, N2, shown in FIGS. 2 to 6, at the ends of the strap G are used for securement of the strap construction to the musical instrument case. FIGS. 1 and 7 show different types of securement in the form of end members S1, S2, which, as shown in FIG. 1, may include a quick-action closure, or, as shown in FIG. 7, may include a snap hook K1, K2. Moreover, the intermediate strap portion T13, shown in FIG. 6, may be arched. Any of the straps shown in FIGS. 1 to 7 may thus be firmly securable to a musical instrument case, e.g. by sewing, riveting, gluing, etc., or detachably securable, e.g. by snap hooks, quick-action closures, velcro, pressure knobs, etc. The same applies for securement of a strap construction according to the present invention to a musical instrument.

The strap constructions shown in FIGS. 1 to 7, which may, of course, also include two straps to provide a knapsack strap configuration, and the strap construction of FIG. 8 result in a slight resiliency and cushioning of the case, as the bearer moves. As the strap construction can be subjected to and is thus responsive to tensile stress in longitudinal direction, the bearer has thus the feeling that the case and the accommodated musical instrument are easy to carry so that the mind-set of the bearer is not adversely affected, even though the weight of the case has, in fact, not changed.

Of course, the strap constructions shown in FIGS. 1 to 8 are equally applicable for direct securement to a musical instrument, without use of a musical instrument case.

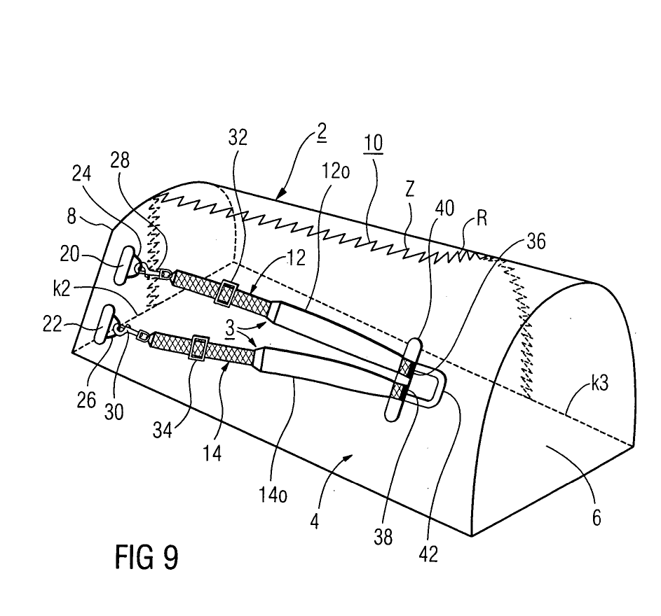

Referring now to FIG. 9, there is shown a perspective illustration of a musical instrument case in the form of a carrying bag, generally designated by reference numeral 2, for accommodating a wind instrument. The carrying bag 2 includes a strap construction according to the present invention, generally designated by reference numeral 3 in knapsack configuration on the right side of the carrying bag 2. The carrying bag 2 has a plane trapezoidal base area 4, with a semi-circular planar front side 6 and a smaller semi-circular rear side 8. Reference numeral 10 designates a zipper which extends from a lower edge k2 at the margin or, as shown here, in midsection across the rear side 8, in a straight line across the upper surface of the carrying bag 2 to a point Z, and from there along a curved course R until terminating at the left-hand edge k3 of the trapezoidal base area 4.

The carrying bag 2 is shown here in upright position, when carried so that the front side 6 points upwards and the rear side 8 points downwards. The strap construction 3 in knapsack configuration includes two support straps 12, 14 of adjustable lengths. In correspondence with FIG. 4, the upper strap portions 12o, 14o of the straps 12, 14 are made of neoprene.

The support straps 12, 14 are secured as follows: two spaced-apart lower mounts 20, 22 are permanently sewn to the lower part of the carrying bag 2. The lower mounts 20, 22 are situated approximately at hip level of the bearer carrying the bag 2. Mount 20 includes a ring 24 for attachment of a snap hook 28 connected to the lower end of the support strap 12, and mount 22 includes a ring 26 for attachment of a snap hook 30 connected to the lower end of the support strap 14. The straps 12, 14 are so disposed as to converge in upward direction in the form of a wedge, as shown in FIG. 9. As an alternative, the lower ends of the straps 12, 14 may, of course, be directly sewn, riveted, or connected via a quick-action closure to the carrying bag 2.

Slides 32, 24 are further provided on the straps 12, 14 for providing a length adjustment thereof. The upper ends of the straps 12, 14 terminate in fasteners 36, 38 which are sewn to the upper mount 40. The upper mount 40 is situated approximately at shoulder level of the bearer carrying the bag 2 and may be adjustably constructed in relation to the distance to the mounts 20, 22. Handle 42 is further secured to the upper mount 40 for handling the bag 2, especially when carried or slipped over the bearer's shoulders.

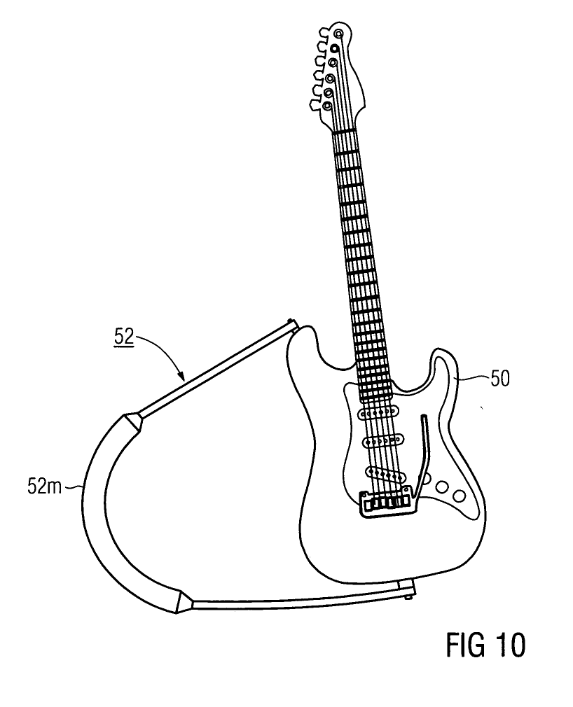

FIG. 10 shows a plan view of an exemplary guitar 50 provided with a strap construction according to the present invention, generally designated by reference numeral 52 and designed as shoulder strap. The shoulder strap 52 has ends which can be threadably secured to the guitar 50 for rotational movement. Corresponding to the strap construction of FIG. 6, the shoulder strap 52 includes in midsection a slightly thicker strap portion 52m made of neoprene.

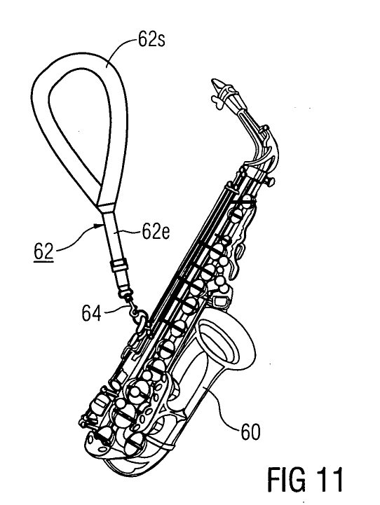

FIG. 11 is a perspective view of an exemplary saxophone 60 provided with a strap construction according to the present invention, generally designated by reference numeral 62 and designed as neck strap 62. The neck strap 62 includes a neck loop 62s, which is worn around the neck of the musician and made of neoprene, and an end member 62e, which is clipped to the saxophone 60 by a snap hook 64 at the end of the end member 62e.

While the invention has been illustrated and described in connection with currently preferred embodiments shown and described in detail, it is not intended to be limited to the details shown since various modifications and structural changes may be made without departing in any way from the spirit of the present invention. Of course, any of the illustrated configurations, depicted in FIGS. 12 to 23 is applicable to any of the strap constructions shown in FIGS. 1 to 11, including for any of the strap portions thereof. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A strap construction for attachment to a musical instrument or a musical instrument case, comprising a strap; and an attachment member connected to the strap, wherein at least one member selected from the group consisting of the strap, part of the strap, and the attachment member, is made of a highly elastic material comprised of chloroprene rubber so as to be responsive to tensile stress.

2. The strap construction of claim 1, wherein the elastic material is lined with a layer of nylon-jersey.

3. The strap construction of claim 1, wherein the strap construction has a first strap portion made of the elastic material, and a second strap portion made of traditional web construction material.

4. The strap construction of claim 3, wherein the second strap portion is made of propylene.

5. The strap construction of claim 3, wherein at least one of the first and second strap portions is padded.

6. The strap construction of claim 3, and further comprising a connection piece for interconnecting the first and second strap portions.

7. The strap construction of claim 6, wherein the connection piece is made of stable material.

8. The strap construction of claim 7, wherein the connection piece is made of a material selected from the group consisting of flexible plastic, synthetic material, and leather.

9. The strap construction of claim 6, wherein the connection piece is secured to at least one of the first and second strap portions by a process selected from the group consisting of sewing, riveting, and gluing.

10. The strap construction of claim 3, and further comprising a further one of said first strap portion, said second strap portion being disposed between the two first strap portions.

11. The strap construction of claim 3, and further comprising a further one of said second strap portion, said first strap portion being disposed between the two second strap portions.

12. The strap construction of claim 1, wherein the strap has opposite ends, at least one of the ends being constructed for application of a seam.

13. The strap construction of claim 1, wherein the strap has opposite ends, at least one of the ends having an end member for attachment.

14. The strap construction of claim 13, wherein the end member includes a snap hook or clip.

15. The strap construction of claim 13, wherein the end member is constructed for securement to the musical instrument case or attachment member by a process selected from the group consisting of riveting and sewing.

16. The strap construction of claim 1, wherein the strap is made of traditional web construction material, said attachment member being made of the highly elastic material.

17. The strap construction of claim 16, wherein the web construction material is propylene.

18. The strap construction of claim 1, and further comprising a further one of said strap, said attachment member being constructed for securement of the two straps to form a knapsack strap configuration.

19. The strap construction of claim 1, wherein the attachment member is constructed for application of a seam or rivets for securement to the musical instrument case.

20. The strap construction of claim 1, wherein the attachment member is constructed for detachable securement to the musical instrument case.

21. The strap construction of claim 1, wherein the strap is detachably secured to the attachment member.

22. The strap construction of claim 1, wherein the strap has a bearer-proximal surface of non-planar extension so as to exhibit an arcuate configuration.

23. The strap construction of claim 1, wherein the strap is curved to the left or to the right.

24. The strap construction of claim 1, wherein the strap has a bearer-proximal surface having a non-rectangular configuration.

25. The strap construction of claim 24, wherein the strap has a non-rectangular configuration selected from the group consisting of convex configuration, concave configuration, bottle-shaped configuration, and trapezoidal configuration.

26. The strap construction of claim 1, wherein the member is made of two chloroprene rubber layers and an intermediate layer between the chloroprene rubber layers.

27. A musical instrument case, comprising:
a shell having an interior for accommodating a musical instrument; and
a strap construction for attachment to the shell, said strap construction including a strap; and an attachment member connected to the strap, wherein at least one member selected from the group consisting of the strap, part of the strap, and the attachment member, is made of a highly elastic material comprised of chloroprene rubber so as to be responsive to tensile stress.

28. A musical instrument, comprising a strap construction for attachment to the musical instrument, said strap construction including a strap; and an attachment member connected to the strap, wherein at least one member selected from the group consisting of the strap, part of the strap, and the attachment member, is made of a highly elastic material comprised of chloroprene rubber so as to be responsive to tensile stress:
